(19) United States
(12) Patent Application Publication
(10) Pub. No.: US 2026/0322713 A1
(43) Pub. Date: Oct. 15, 2026

(54) FEATURE COMPATIBILITY AND ACCESS-POINT REQUIREMENT VERIFICATION

(71) Applicant: Ruckus IP Holdings LLC, Horsham, PA (US)

(72) Inventors: Po Han Hao, New Taipei City (TW); Chia Chuan Leng, Taipei (TW); Chiayen Chien, New Taipei City (TW); Chi Shin Hsu, New Taipei City (TW); Yi-Wen Chen, New Taipei City (TW); Hsien Tsung Wu, Taipei City (TW)

(21) Appl. No.: 19/639,903

(22) Filed: Apr. 6, 2026

Related U.S. Application Data
(60) Provisional application No. 63/786,352, filed on Apr. 10, 2025.

(51) Int. Cl. H04L 41/22

(52) U.S. Cl. CPC H04L 41/22

(57) ABSTRACT

A computer system that assesses compatibility is described. During operation, the computer system may access or receive, associated with an electronic device (such as an access point, a switch or a router), information indicating whether the electronic device supports a feature or functionality, where the information includes a model of the electronic device or a software version installed on the electronic device. Then, the computer system may provide a user interface with an indication of compatibility based at least in part on the information. Note that the computer system may assess the compatibility of the electronic device with the feature or functionality based at least in part on the model of the electronic device or the software version installed on the electronic device, and the user interface with the indication may be provided based at least in part on the assessment.

### CROSS-REFERENCE TO RELATED APPLICATION

This application claims priority to U.S. Provisional Patent Application No. 63/786,352, filed on Apr. 10, 2025, the contents of which are incorporated herein by reference in its entirety.

### FIELD

The described embodiments relate to techniques for indicating feature support for a computer-network device, such as an access point.

### BACKGROUND

Many electronic devices are capable of wirelessly communicating with other electronic devices. In particular, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth from the Bluetooth Special Interest Group of Kirkland, Washington), and/or another type of wireless network. For example, many electronic devices communicate with each other via wireless local area networks (WLANs) using an IEEE 802.11-compatible communication protocol (which is sometimes collectively referred to as ‘Wi-Fi’). In a typical deployment, a Wi-Fi-based WLAN includes one or more access points (or basic service sets or BSSs) that communicate wirelessly with each other and with other electronic devices using Wi-Fi, and that provide access to another network (such as the Internet) via IEEE 802.3 (which is sometimes referred to as ‘Ethernet’).

One challenge with electronic devices used in networks (which are sometimes referred to as ‘computer-network devices’) is ensuring compatibility. Notably, computer-network devices often have different hardware and/or software versions. Consequently, these computer-network devices may not support the same features or functionality. However, it can be difficult for a network operator or a user of a network that includes heterogenous computer-network devices to know or understand which features or functions are supported by a given computer-network device.

### SUMMARY

A computer system that assesses compatibility is described. This computer system includes an interface circuit that communicates with an electronic device. During operation, the computer system accesses or receives, associated with the electronic device, information indicating whether the electronic device supports a feature or functionality, where the information includes a model of the electronic device or a software version installed on the electronic device. Then, the computer system provides a user interface with an indication of compatibility based at least in part on the information.

Note the electronic device may include an access point. More generally, the electronic device may include a computer-network device, such as a switch or a router.

Moreover, the model of the electronic device may specify hardware associated with the electronic device. Furthermore, the software version may include a firmware version. Additionally, the computer system may assess the compatibility of the electronic device with the feature or functionality based at least in part on the model of the electronic device or the software version installed on the electronic device, and the user interface with the indication may be provided based at least in part on the assessment.

Furthermore, when the electronic device does not support the feature or the functionality, the user interface may selectively indicate a remedial action needed to enable the electronic device to support the feature or the functionality. In some embodiments, the computer system may receive user-interface activity associated with a user, and the remedial action may be selectively indicated in the user interface in response to the user-interface activity. For example, the user-interface activity may include the user selectively requesting the remedial action, such as by selectively activating a user-interface feature (e.g., selectively activating a button or an icon in or associated with the user interface).

Another embodiment provides the electronic device that performs counterpart operations to at least some of the aforementioned operations of the computer system.

Another embodiment provides a computer-readable storage medium with program instructions for use with one of the computer system or the electronic device. When executed by the computer system or the electronic device, the program instructions cause the computer system or the electronic device to perform at least some of the aforementioned operations in one or more of the preceding embodiments.

Another embodiment provides a method, which may be performed by the computer system or the electronic device. This method includes at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for assessing compatibility using a computer system in FIG. 1 in accordance with an embodiment of the present disclosure.

FIG. 3 is a block diagram illustrating an example of communication among an access point, an electronic device and a computer system in accordance with an embodiment of the present disclosure.

FIG. 4 is a drawing illustrating an example of a user interface in accordance with an embodiment of the present disclosure.

FIG. 5 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system that assesses compatibility is described. During operation, the computer system may access or receive, associated with an electronic device (such as an access point, a switch or a router), information indicating whether the electronic device supports a feature or functionality, where the information includes a model of the electronic device or a software version installed on the electronic device. Then, the computer system may provide a user interface with an indication of compatibility based at least in part on the information. Note that the computer system may assess the compatibility of the electronic device with the feature or functionality based at least in part on the model of the electronic device or the software version installed on the electronic device, and the user interface with the indication may be provided based at least in part on the assessment.

By providing the indication in the user interface, these compatibility techniques may provide a visual and intuitive indication of the capabilities of the electronic device. This situational awareness may allow a user (such as a network operator) to understand why the electronic device does or does not provide the feature or the functionality. In addition, when the electronic device is not compatible with the feature or the functionality, the compatibility techniques may provide instructions (such as a remedial action) that will enable the electronic device to support the feature or the functionality. Consequently, the compatibility techniques may improve the understanding of the user and may simplify operation of a network that includes the electronic device. Therefore, the compatibility techniques may reduce user frustration and may improve the user experience when using the electronic device, the computer system and/or the network.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Texas), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi, LTE and Ethernet are used as illustrative examples.

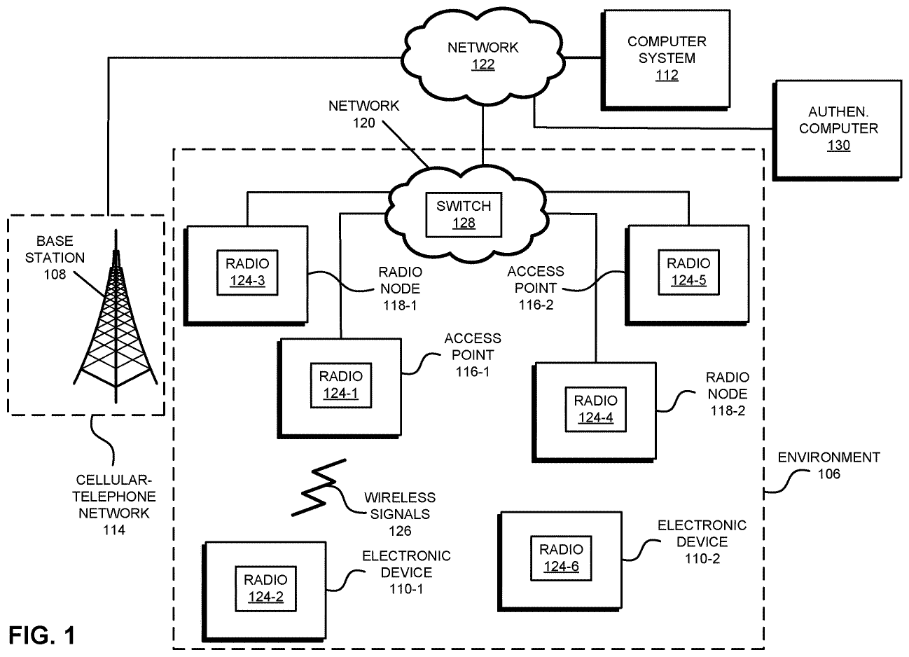

We now describe some embodiments of the compatibility techniques. FIG. 1 presents a block diagram illustrating an example of communication in an environment 106 with one or more electronic devices 110 (such as cellular telephones, portable electronic devices, stations or clients, another type of electronic device, etc., which are sometimes referred to as ‘end devices’) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device’ or a ‘computer-network device’). Moreover, as noted previously, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other, computer system 112 (which may be a cloud-based controller that manages and/or configures access points 116, radio nodes 118 and/or switch 128, or that provides cloud-based storage and/or analytical services) and/or authentication computer 130 (such as a RADIUS server and/or an AAA server) using a wired communication protocol (such as Ethernet) via network 120 and/or 122. Note that networks 120 and 122 may be the same or different networks. For example, networks 120 and/or 122 may be: an LAN, an intra-net or the Internet. In some embodiments, network 120 may include one or more routers and/or switches (such as switch 128). In FIG. 1, note that a controller may provide various management, control and cluster functionalities, which may include: network management of access points; performing some of control plane functions (such as roaming); maintaining statistics related to traffic, health of access points, top applications used, number of clients and their capabilities; and/or other functions or functionality.

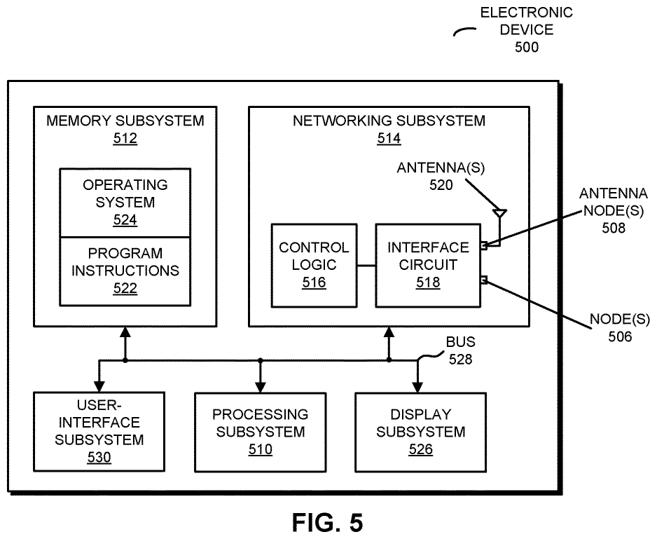

As described further below with reference to FIG. 5, electronic devices 110, computer system 112, access points 116, radio nodes 118, switch 128 and authentication computer 130 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, it may be difficult for a user (such as a network operator) to understand the capabilities of disparate electronic devices (such as access points 116) in a network, especially when these electronic devices have heterogeneous hardware and/or software (such as firmware). In order to address this problem, a computer system (such as computer system 112) may perform the compatibility techniques. Notably, computer system 112 may access (e.g., in memory in or associated with computer system 112) information indicating whether access point 116-1 supports a feature or functionality, where the information includes a model of access point 116-1 or a software version installed on access point 116-1. Alternatively or additionally, computer system 112 may receive the information from access point 116-1.

Note that the model of access point 116-1 may specify hardware associated with the electronic device and/or the software version may include a firmware version. In some embodiments, computer system 112 may assess the compatibility of access point 116-1 with the feature or functionality based at least in part on the model of access point 116-1 and/or the software version installed on access point 116-1.

Then, computer system 112 may provide a user interface with an indication of compatibility based at least in part on the information. For example, the user interface may be provided to a computer or a computer system (not shown) used by a user, such as a network operator. Note that the user interface with the indication may be provided based at least in part on the assessment.

Moreover, when access point 116-1 does not support the feature or the functionality, the user interface may selectively indicate a remedial action needed to enable access point 116-1 to support the feature or the functionality. In some embodiments, computer system 112 may receive user-interface activity associated with a user, and the remedial action may be selectively indicated in the user interface in response to the user-interface activity. For example, the user-interface activity may include the user selectively requesting the remedial action, such as by selectively activating a user-interface feature (e.g., selectively activating a button or an icon in or associated with the user interface, on a keyboard, etc.).

In these ways, the compatibility techniques may provide a visual and intuitive indication of the capabilities of access point 116-1. This situational awareness may allow a user (such as a network operator) to understand why access point 116-1 does or does not provide the feature or the functionality. Consequently, the compatibility techniques may improve the understanding of the user and may simplify operation of a network that includes access point 116-1. Therefore, the compatibility techniques may reduce user frustration and may improve the user experience when using access point 116-1, computer system 112 and/or the network.

While the preceding discussion illustrated computer system 112 performing the operations in the compatibility techniques, in other embodiments at least some of the operations may be performed by or in conjunction with another component in FIG. 1.

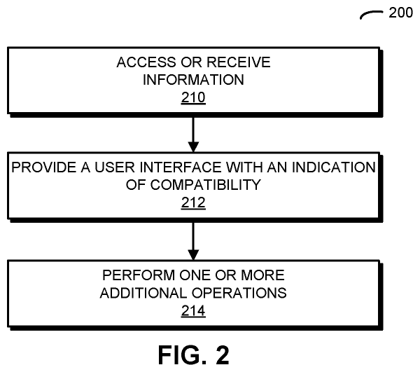

We now describe embodiments of the method. FIG. 2 presents a flow diagram illustrating an example of a method 200 for assessing compatibility, which may be performed by a computer system, such as computer system 112 in FIG. 1. During operation, the computer system may access or receive, associated with an electronic device, information (operation 210) indicating whether the electronic device supports a feature or functionality, where the information includes a model of the electronic device or a software version installed on the electronic device. Then, the computer system may provide a user interface with an indication of compatibility (operation 212) based at least in part on the information.

Note the electronic device may include an access point. More generally, the electronic device may include a computer-network device, such as a switch or a router.

Moreover, the model of the electronic device may specify hardware associated with the electronic device. Furthermore, the software version may include a firmware version.

In some embodiments, the computer system may optionally perform one or more optional additional operations (operation 214). For example, the computer system may assess the compatibility of the electronic device with the feature or functionality based at least in part on the model of the electronic device or the software version installed on the electronic device, and the user interface with the indication may be provided based at least in part on the assessment.

Moreover, when the electronic device does not support the feature or the functionality, the user interface may selectively indicate a remedial action needed to enable the electronic device to support the feature or the functionality. In some embodiments, the computer system may receive user-interface activity associated with a user, and the remedial action may be selectively indicated in the user interface in response to the user-interface activity. For example, the user-interface activity may include the user selectively requesting the remedial action, such as by selectively activating a user-interface feature (e.g., selectively activating a button or an icon in or associated with the user interface).

In some embodiments of method 200, there may be additional or fewer operations. Furthermore, the order of the operations may be changed, and/or two or more operations may be combined into a single operation.

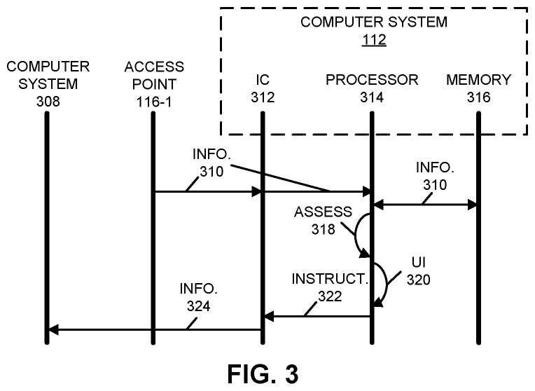

FIG. 3 presents a drawing illustrating an example of communication between computer system 308, computer system 112 and access point 116-1. Notably, access point 116-1 may provide, addressed to computer system 112, information 310 indicating whether access point 116-1 supports a feature or functionality, where information 310 includes a model of access point 116-1 or a software version installed on access point 116-1. This information may be received by an interface circuit (IC) 312 in access point 116-1, which may provide information 310 to processor 314 in access point 16-1. Alternatively or additionally, processor 314 may access information 310 in memory 316 in access point 116-1.

Then, processor 314 may assess 318 compatibility of access point 116-1 with the feature or functionality based at least in part on information 310, which may specify a model of access point 116-1 or the software version installed on access point 116-1. Next, processor 314 may generate or modify instructions for a user interface (UI) 320 with an indication of compatibility based at least in part on information 310 and/or assessment 318. Moreover, processor 314 may instruct 322 interface circuit 312 to provide information 324 specifying the user interface to computer system 308, which may display the user interface based at least in part on the instructions for the user interface to a user, such as a network operator of a network that includes access point 116-1.

While FIG. 3 illustrates some operations using unilateral or bilateral communication (which are, respectively, represented by one-sided and two-sided arrows), in general a given operation in FIG. 3 may involve unilateral or bilateral communication. Moreover, while FIG. 3 illustrates operations being performed sequentially or at different times, in other embodiments at least some of these operations may, at least in part, be performed concurrently or in parallel.

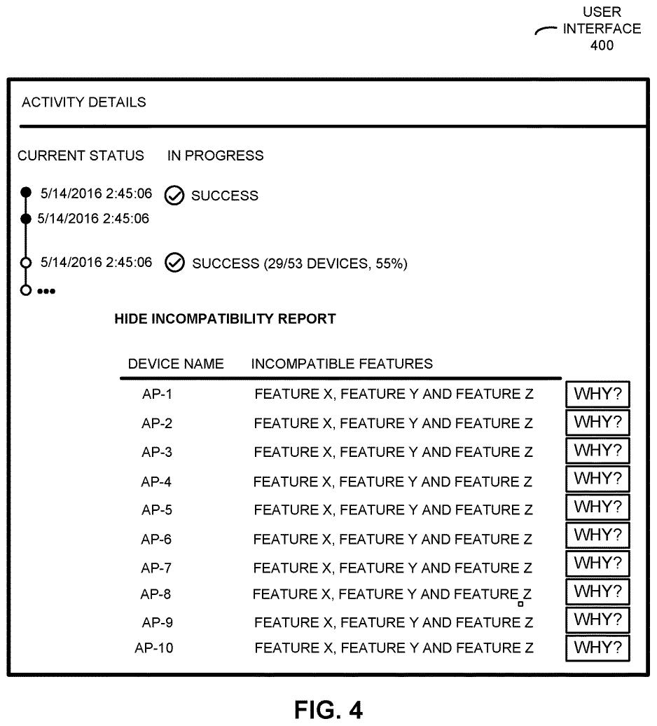

FIG. 4 presents a drawing illustrating an example of a user interface 400. This user interface may include an indication of compatibility of electronic devices (such as an access point, a router or a switch) in a network with a feature or functionality. For example, user interface 400 may indicate that certain electronic devices are incompatible with the feature or the functionality, such as features A, B and C. Moreover, user interface 400 may include buttons or icons (“Why?”) that allow a user to selectively request more information about the incompatibility and/or associated remedial action to restore or provide compatibility.

We now further describe the compatibility techniques. As noted previously, a feature or functionality may be incompatible with certain hardware and/or software configurations. This may cause confusion for a user, such as a network operator. The disclosed compatibility techniques may address this problem by determining whether an access-point model or a firmware version supports a feature or functionality. For example, based at least in part on a database or data structure, a computer system may check for compatibility. Alternatively or additionally, the computer system may compare a venue identifier with a firmware version and/or a model number. In some embodiments, wireless-screen mirroring (e.g., QS mirroring) may be used to provide a list or compatible or incompatible electronic devices. When the feature or functionality is not supported, a user interface (such as a graphical user interface) may be modified to include an indication of incompatibility for the feature or the functionality. Moreover, a user may selectively view additional details about the incompatibility, including, e.g., any remedial action that is needed.

Note that the incompatibility may occur when management plane services running, e.g., in the cloud are upgraded at higher frequency than electronic-device (e.g., access point) firmware releases. A new feature added to the cloud may be exposed to multiple customers. For those customers that did not upgrade their electronic devices to the latest firmware version, the new feature may not work for them. In order to address this issue, the user interface for a cloud-based controller or computer system may inform a customer that certain features are not supported on some impacted electronic devices. Moreover, the user interface may include troubleshooting capabilities to identify the errors caused by incompatible electronic-device firmware versions and/or associated remedial action (such as firmware update to a particular firmware version) to provide compatibility on the impacted or affected electronic devices.

We now describe embodiments of an electronic device, which may perform at least some of the operations in the compatibility techniques. FIG. 5 presents a block diagram illustrating an example of an electronic device 500 in accordance with some embodiments, such as one of: base station 108, one of electronic devices 110, computer system 112, one of access points 116, one of radio nodes 118, switch 128 or authentication computer 130. This electronic device includes processing subsystem 510, memory subsystem 512, and networking subsystem 514. Processing subsystem 510 includes one or more devices configured to perform computational operations. For example, processing subsystem 510 can include one or more microprocessors, graphics processing units (GPUs), ASICs, microcontrollers, programmable-logic devices, and/or one or more digital signal processors (DSPs).

Memory subsystem 512 includes one or more devices for storing data and/or instructions for processing subsystem 510 and networking subsystem 514. For example, memory subsystem 512 can include DRAM, static random access memory (SRAM), and/or other types of memory. In some embodiments, instructions for processing subsystem 510 in memory subsystem 512 include: one or more program modules or sets of instructions (such as program instructions 522 or operating system 524, such as Linux, UNIX, Windows Server, or another customized and proprietary operating system), which may be executed by processing subsystem 510. Note that the one or more computer programs, program modules or instructions may constitute a computer-program mechanism. Moreover, instructions in the various modules in memory subsystem 512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 510.

In addition, memory subsystem 512 can include mechanisms for controlling access to the memory. In some embodiments, memory subsystem 512 includes a memory hierarchy that comprises one or more caches coupled to a memory in electronic device 500. In some of these embodiments, one or more of the caches is located in processing subsystem 510.

In some embodiments, memory subsystem 512 is coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by electronic device 500 as fast-access storage for often-used data, while the mass-storage device is used to store less frequently used data.

Networking subsystem 514 includes one or more devices configured to couple to and communicate on a wired and/or wireless network (i.e., to perform network operations), including: control logic 516, an interface circuit 518 and one or more antennas 520 (or antenna elements). (While FIG. 5 includes one or more antennas 520, in some embodiments electronic device 500 includes one or more nodes, such as antenna nodes 508, e.g., a metal pad or a connector, which can be coupled to the one or more antennas 520, or nodes 506, which can be coupled to a wired or optical connection or link. Thus, electronic device 500 may or may not include the one or more antennas 520. Note that the one or more nodes 506 and/or antenna nodes 508 may constitute input(s) to and/or output(s) from electronic device 500.) For example, networking subsystem 514 can include a Bluetooth™ networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi® networking system), an Ethernet networking system, and/or another networking system.

Note that a transmit or receive antenna pattern (or antenna radiation pattern) of electronic device 500 may be adapted or changed using pattern shapers (such as directors or reflectors) and/or one or more antennas 520 (or antenna elements), which can be independently and selectively electrically coupled to ground to steer the transmit antenna pattern in different directions. Thus, if one or more antennas 520 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 500 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 500 may use the mechanisms in networking subsystem 514 for performing simple wireless communication between the electronic devices, e.g., transmitting advertising or beacon frames and/or scanning for advertising frames transmitted by other electronic devices as described previously.

Within electronic device 500, processing subsystem 510, memory subsystem 512, and networking subsystem 514 are coupled together using bus 528. Bus 528 may include an electrical, optical, and/or electro-optical connection that the subsystems can use to communicate commands and data among one another. Although only one bus 528 is shown for clarity, different embodiments can include a different number or configuration of electrical, optical, and/or electro-optical connections among the subsystems.

In some embodiments, electronic device 500 includes a display subsystem 526 for displaying information on a display, which may include a display driver and the display, such as a liquid-crystal display, a multi-touch touchscreen, etc.

Moreover, electronic device 500 may include a user-interface subsystem 530, such as: a mouse, a keyboard, a trackpad, a stylus, a voice-recognition interface, and/or another human-machine interface. In some embodiments, user-interface subsystem 530 may include or may interact with a touch-sensitive display in display subsystem 526.

Electronic device 500 can be (or can be included in) any electronic device with at least one network interface. For example, electronic device 500 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 500, in alternative embodiments, different components and/or subsystems may be present in electronic device 500. For example, electronic device 500 may include one or more additional processing subsystems, memory subsystems, networking subsystems, and/or display subsystems. Additionally, one or more of the subsystems may not be present in electronic device 500. Moreover, in some embodiments, electronic device 500 may include one or more additional subsystems that are not shown in FIG. 5. Also, although separate subsystems are shown in FIG. 5, in some embodiments some or all of a given subsystem or component can be integrated into one or more of the other subsystems or component(s) in electronic device 500. For example, in some embodiments instructions 522 is included in operating system 524 and/or control logic 516 is included in interface circuit 518.

Moreover, the circuits and components in electronic device 500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 514 and/or of electronic device 500. The integrated circuit may include hardware and/or software mechanisms that are used for transmitting wireless signals from electronic device 500 and receiving signals at electronic device 500 from other electronic devices. Aside from the mechanisms herein described, radios are generally known in the art and hence are not described in detail. In general, networking subsystem 514 and/or the integrated circuit can include any number of radios. Note that the radios in multiple-radio embodiments function in a similar way to the described single-radio embodiments.

In some embodiments, networking subsystem 514 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals).

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi, LTE and/or Ethernet communication protocols as illustrative examples, in other embodiments a wide variety of communication protocols and, more generally, communication techniques may be used. Thus, the compatibility techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the compatibility techniques may be implemented using program instructions 522, operating system 524 (such as a driver for interface circuit 518) or in firmware in interface circuit 518. Alternatively or additionally, at least some of the operations in the compatibility techniques may be implemented in a physical layer, such as hardware in interface circuit 518.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. A computer system, comprising:
an interface circuit configured to communicate with an electronic device, wherein the computer system is configured to perform operations comprising:
accessing or receiving, associated with the electronic device, information indicating whether the electronic device supports a feature or functionality, wherein the information comprises a model of the electronic device or a software version installed on the electronic device; and
providing a user interface with an indication of compatibility based at least in part on the information.

2. The computer system of claim 1, wherein the electronic device comprises an access point, a switch or a router.

3. The computer system of claim 1, wherein the model of the electronic device specifies hardware associated with the electronic device.

4. The computer system of claim 1, wherein the software version comprises a firmware version.

5. The computer system of claim 1, wherein the operations comprise assessing the compatibility of the electronic device with the feature or functionality based at least in part on the model of the electronic device or the software version installed on the electronic device, and
wherein the user interface with the indication is provided based at least in part on the assessment.

6. The computer system of claim 1, wherein, when the electronic device does not support the feature or the functionality, the user interface selectively indicates a remedial action needed to enable the electronic device to support the feature or the functionality.

7. The computer system of claim 6, wherein the operations comprise receiving user-interface activity associated with a user, and
wherein the remedial action is selectively indicated in the user interface in response to the user-interface activity.

8. The computer system of claim 7, wherein the user-interface activity corresponds to a selective request for information about the remedial action.

9-14. (canceled)

15. A method for assessing compatibility, comprising:
by a computer system:
accessing or receiving, associated with an electronic device, information indicating whether the electronic device supports a feature or functionality, wherein the information comprises a model of the electronic device or a software version installed on the electronic device; and
providing a user interface with an indication of compatibility based at least in part on the information.

16. The method of claim 15, wherein the electronic device comprises an access point, a switch or a router.

17. The method of claim 15, wherein the model of the electronic device specifies hardware associated with the electronic device or the software version comprises a firmware version.

18. The method of claim 15, wherein the method comprises assessing the compatibility of the electronic device with the feature or functionality based at least in part on the model of the electronic device or the software version installed on the electronic device, and
wherein the user interface with the indication is provided based at least in part on the assessment.

19. The method of claim 15, wherein, when the electronic device does not support the feature or the functionality, the user interface selectively indicates a remedial action needed to enable the electronic device to support the feature or the functionality.

20. The method of claim 19, wherein the method comprises receiving user-interface activity associated with a user, and
wherein the remedial action is selectively indicated in the user interface in response to the user-interface activity.

21. A computer system for verifying compatibility of access points in a network, comprising:
an interface circuit configured to communicate with a plurality of access points in the network;
a processor coupled to the interface circuit and configured to perform operations comprising:
accessing, from a database or a data structure, requirement information for a feature or functionality;
accessing or receiving, for the plurality of access points, device information comprising, for each access point, a model of the access point or a software version installed on the access point;
assessing, based at least in part on the requirement information and the device information, compatibility of the plurality of access points with the feature or functionality;
providing a user interface including an indication that identifies one or more of the plurality of access points as incompatible with the feature or functionality; and
in response to user-interface activity associated with a user, selectively indicating in the user interface additional information about the incompatibility or a remedial action needed to enable the one or more access points to support the feature or functionality.

22. The computer system of claim 1, wherein the operations comprise checking compatibility using a database or a data structure that associates the feature or functionality with a minimum firmware version or a required model for the electronic device.

23. The computer system of claim 1, wherein the indication of compatibility comprises an incompatibility report listing the electronic device by device name and listing one or more incompatible features for the electronic device.

24. The computer system of claim 1, wherein the user interface comprises a selectable button or icon that allow a user to selectively request more information about the incompatibility and/or associated remedial action to restore or provide compatibility.

25. The computer system of claim 1, wherein the operations comprise comparing a venue identifier associated with the electronic device with the software version installed on the electronic device or the model of the electronic device.

26. The computer system of claim 1, wherein the indication of compatibility indicates that a feature or functionality exposed by management plane services running in a cloud is unsupported on the electronic device because the software version installed on the electronic device is incompatible.
